(19) United States
(12) Patent Application Publication
(10) Pub. No.: US 2026/0252388 A1
(43) Pub. Date: Aug. 27, 2026

(54) HORIZONTAL POD AUTOSCALING BASED ON REAL-TIME REQUEST RATE

(71) Applicant: International Business Machines Corporation, Armonk, NY (US)

(72) Inventors: Zhan Peng Huo, BEIJING (CN); Yu Zui You, Ningbo (CN); Xiao Ling Chen, BEIJING (CN); Heng Wang, Changping District (CN)

(21) Appl. No.: 19/060,710

(22) Filed: Feb. 23, 2025

(51) Int. Cl. G06F 9/50

(52) U.S. Cl. CPC G06F 9/5011; G06F 9/5077

(57) ABSTRACT

Horizontal pod autoscaling based on real-time request rate includes detecting a trigger associated with the scaling of a set of pods. A count of a set of real-time requests accessing a service of an application based on the trigger is determined. A health ratio value is obtained for each pod of the set of pods. An available request handling capacity is determined for each pod of the set of pods based on the trigger. An empirical coefficient value is determined based on a set of metrics associated with the set of pods. A scaling coefficient is calculated based on the count of the set of real-time requests, the health ratio value, the available request handling capacity value, and the empirical coefficient value. The set of pods is modified based on the scaling coefficient and an instantiation of the modified set of pods is controlled.

### BACKGROUND

The disclosure relates to containerized applications and more particularly, to autoscaling in containerized applications.

Containerized applications are software packages that encapsulate an application and its dependencies, such as libraries and frameworks, into a single unit called a container. This technology allows applications to run seamlessly across various computing environments, including different operating systems and cloud infrastructures. Scaling in containerized applications involves dynamically adjusting the number of container instances or their resource allocations to handle varying workload demands. The scaling helps maintain application performance, productive resource utilization, and cost-effectiveness. The flexibility of containerized architecture makes scaling a need for ensuring high availability and responsiveness in modern distributed systems.

### SUMMARY

In various embodiments of the disclosure, a computer-implemented method for horizontal pod autoscaling based on real-time request rate is described. The computer-implemented method includes detecting, by a computer, a trigger associated with a scaling of a set of pods associated with an application. The set of pods implements a service provided by the application. The computer-implemented method further includes determining, by the computer, a count of a set of real-time requests for accessing the service of the application. The count of the set of real-time requests is determined based on the trigger. The computer-implemented method further includes obtaining, by the computer, a health ratio value for each pod of the set of pods based on the trigger. The computer-implemented method further includes determining, by the computer, an available request handling capacity value for each pod of the set of pods based on the trigger. The computer-implemented method further includes determining, by the computer, an empirical coefficient value based on a set of metrics associated with the set of pods. The computer-implemented method further includes calculating, by the computer, a scaling coefficient based on the count of the set of real-time requests, the health ratio value, the available request handling capacity value, and the empirical coefficient value. The scaling coefficient is associated with the scaling of the set of pods. The computer-implemented method further includes modifying, by the computer, the set of pods based on the scaling coefficient and a count of the set of pods. The computer-implemented method further includes controlling, by the computer, an instantiation of the modified set of pods.

In various embodiments of the disclosure, a computer system for horizontal pod autoscaling based on real-time request rate is described. The computer system includes a processor set, one or more computer-readable storage media, and program instructions stored on the one or more computer-readable storage media. The program instructions are executable by the processor set and cause the processor set to detect a trigger associated with a scaling of a set of pods associated with an application. The set of pods implements a service provided by the application. The program instructions further cause the processor set to determine a count of a set of real-time requests for accessing the service of the application. The count of the set of real-time requests is determined based on the trigger. The program instructions further cause the processor set to obtain a health ratio value for each pod of the set of pods based on the trigger. The program instructions further cause the processor set to determine an available request handling capacity value for each pod of the set of pods based on the detected trigger. The program instructions further cause the processor set to determine an empirical coefficient value based on a set of metrics associated with the set of pods. The program instructions further cause the processor set to calculate a scaling coefficient based on a count of the set of real-time requests, the health ratio value, the available request handling capacity value, and the empirical coefficient value. The scaling coefficient is associated with the scaling of the set of pods. The program instructions further cause the processor set to modify the set of pods based on the scaling coefficient and a count of the set of pods. The program instructions further cause the processor set to control an instantiation of the modified set of pods. The program instructions further cause the processor set to route the set of real-time requests to the modified set of pods based on the instantiation of the modified set of pods.

In various embodiments of the disclosure, a computer-program product for horizontal pod autoscaling based on real-time request rate is described.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for horizontal pod autoscaling based on real-time request rate, in accordance with an embodiment of the disclosure;

FIG. 2 is a diagram that illustrates a network environment for horizontal pod autoscaling based on real-time request rate, in accordance with an embodiment of the disclosure;

FIG. 3 is a diagram that illustrates exemplary operations for the generation of a data structure for horizontal pod autoscaling based on real-time requests, in accordance with an embodiment of the disclosure;

FIG. 4 is a diagram that illustrates exemplary operations for the calculation of a scaling coefficient for horizontal pod autoscaling based on real-time requests, in accordance with an embodiment of the disclosure;

FIG. 5 is a diagram that illustrates exemplary operations for modification of a set of pods for horizontal pod autoscaling based on real-time request rate, in accordance with an embodiment of the disclosure;

FIG. 6 is a diagram that illustrates a flowchart of a first exemplary method for horizontal pod autoscaling based on real-time request rate, in accordance with an embodiment of the disclosure; and

FIG. 7 is a diagram that illustrates a flowchart of a second exemplary method for horizontal pod autoscaling based on real-time request rate, in accordance with an embodiment of the disclosure.

### DETAILED DESCRIPTION

The field of containerized application management has rapidly evolved with the adoption of container orchestration platforms. The container orchestration platforms provide a robust ecosystem for deploying, scaling, and managing applications in cloud-native environments. The container orchestration platforms operate on the concept of encapsulating one or more containers alongside their storage, network configurations, and runtime settings into manageable units. The container orchestration platforms utilize static scaling for dynamic and effective resource management. Static scaling mechanisms refer to a method of scaling resources in a system by adding or removing fixed amounts of resources to meet anticipated demands. Static scaling mechanisms, while useful for predictable workloads, fail to address the variability and unpredictability of modern application demands due to fixed resource allocation, lack of real-time adaptation, and manual intervention needed for adjustments in resource allocation which introduces potential human error. This challenge has driven the need for advanced solutions like Horizontal Pod Autoscaler (HPA) and similar features across various orchestration platforms, designed to provide automated, elastic scaling capabilities.

HPA is a component in container orchestration platforms that facilitates horizontal scaling, which refers to dynamic adjustments in the number of pods in a deployment or replica set based on workload metrics such as CPU usage, or memory usage. By continuously monitoring these metrics, HPA ensures that applications maintain consistent performance and resource efficiency. HPA reduces the need for manual scaling interventions. Unlike the static scaling mechanisms, the HPA automatically response to fluctuations in workload improves application availability and enhances operational efficiency and productive resource utilization. Overall, HPA adapts to varying demands, ensuring that resources are allocated effectively while minimizing costs.

The dynamic scaling using HPA simplifies operational workflows and promotes consistency across different deployments. As more businesses turn to container orchestration for their applications, HPA has turned out to be an automated scaling mechanism that fits seamlessly with modern development practices. HPA's dynamic scaling allows businesses to manage peak loads. HPA allows businesses to maintain performance during high-demand periods but also minimizes resource waste when demand is low, which aligns with modern application development practices.

However, managing workload functions remains a challenge in container orchestration platform deployments. Traditional scaling methods often depend on manual interventions, requiring operators to adjust the number of pod replicas based on predefined thresholds. The traditional methods create challenges in fast-paced environments where workload demands keep fluctuating. The delay caused by traditional methods in recognizing fluctuations in demand leads to application downtime, reduced performance, and missed opportunities to serve some user requests. In scenarios where constant availability and responsiveness are needed (such as e-commerce platforms or real-time analytics applications), the traditional methods result in lost revenue for the businesses and hamper customer trust.

While HPA offers automation to address some of these issues, it is primarily resource-driven, relying on metrics like CPU and memory usage to determine scaling actions. This approach, while enough for steady or predictable workloads, struggles in scenarios where traffic patterns are highly irregular or when user request rates surge unexpectedly (e.g. in the case of sales on an e-commerce application or a new product launch). The heavy workload demand overwhelms existing pods, causing them to fail even before new replicas are provisioned. This results in scenarios where initial requests are processed successfully, but subsequent requests are delayed or dropped entirely. Such inconsistencies are detrimental to containerized applications, as such inconsistencies disrupt service continuity and lead to dissatisfactory user experience.

Moreover, the current HPA mechanism lacks the ability to factor in real-time user behavior or workload patterns. For instance, resource metrics such as CPU and memory often lag behind actual user demand, causing scaling decisions to occur too late. This lag in responsiveness exacerbates service disruptions during peak load conditions, creating a bottleneck that limits application scalability and reliability. The inability to handle rapid workload fluctuations effectively undermines the primary goal of containerized applications to provide a scalable and seamless cloud-native infrastructure. To address these challenges, a more advanced scaling methodology that predicts and adapts to real-time user demands is needed, ensuring applications can deliver consistent performance even under extreme load conditions.

The disclosed system provides a way to horizontal pod autoscaling by leveraging real-time request rate metrics and addressing the limitation of the traditional HPA systems. Unlike resource-driven scaling models that rely solely on metrics like CPU and memory usage, the disclosed system leverages real-time user requests to dynamically adjust the number of pods. By closely monitoring and accessing real-time workload patterns, the disclosed system ensures that applications can respond immediately to traffic surges, maintaining consistent performance and high availability even during peak load conditions. This proactive scaling approach minimizes delays in provisioning additional pods, thereby preventing service disruptions and enhancing user satisfaction.

The disclosed system seamlessly integrates with the existing architecture of container orchestration platforms while introducing a more adaptive scaling strategy. By correlating scaling decisions directly with live real-time traffic metrics, the system optimizes resource utilization, ensuring that pods are scaled up only when needed and scaled-down during periods of low demand. This automatic scaling of pods based on real-time traffic metrics reduces operational costs as well as enhances sustainability minimizing resource wastage. The disclosed system ensures that service continuity (or the services provided by the application) is maintained, avoiding scenarios where traffic surges overwhelm existing pods, leading to degraded performance and unsatisfying user experience.

The disclosed system improves the overall productivity and efficiency of containerized deployments. By automating scaling decisions based on real-time request rate, the disclosed system eliminates the need for manual interventions, freeing up the development teams to focus on strategic tasks. The disclosed system has the pre-emptive approach to predict workload fluctuations based on the real-time request rate. The prediction of the workload fluctuations allows the disclosed system to dynamically scale the set of pods. This dynamic scaling avoids request failures or missed requests by routing the workload demand to the scaled-up set of pods. The disclosed system enhances the reliability of applications as well as supports the deployment of complex microservices architectures by ensuring that each service receives the resources to function optimally. The disclosed system dynamically adjusts to workload fluctuations in real-time making the organization achieve robust and scalable cloud-native infrastructures. This advanced autoscaling mechanism based on real-time request rate aligns with the principles of modern cloud-native design by promoting scalability, resilience, and operational efficiency. The disclosed system based on real-time request rate addresses the gaps in traditional scaling methodologies, providing a system that adapts to user demands and ensures consistent application performance. The disclosed system empowers organizations to improve container orchestration platforms, delivering a seamless user experience while improving system reliability.

In various embodiments of the disclosure, a computer-implemented method for horizontal pod autoscaling based on real-time request rate is described. The computer-implemented method includes detecting, by a computer, a trigger associated with a scaling of a set of pods associated with an application. The set of pods implements a service provided by the application. The computer-implemented method further includes determining, by the computer, a count of a set of real-time requests for accessing the service of the application. The count of the set of real-time requests is determined based on the trigger. The computer-implemented method further includes obtaining, by the computer, a health ratio value for each pod of the set of pods based on the trigger. The computer-implemented method further includes determining, by the computer, an available request handling capacity value for each pod of the set of pods based on the trigger. The computer-implemented method further includes determining, by the computer, an empirical coefficient value based on a set of metrics associated with the set of pods. The computer-implemented method further includes calculating, by the computer, a scaling coefficient based on the count of the set of real-time requests, the health ratio value, the available request handling capacity value, and the empirical coefficient value. The scaling coefficient is associated with the scaling of the set of pods. The computer-implemented method further includes modifying, by the computer, the set of pods based on the scaling coefficient and a count of the set of pods. The computer-implemented method further includes controlling, by the computer, an instantiation of the modified set of pods.

In various embodiments of the disclosure, the modification of the set of pods corresponds to an increase in the count of the set of pods associated with the application or a decrease in the count of the set of pods associated with the application.

In various embodiments of the disclosure, the computer-implemented method further includes determining, by the computer, a count of the modified set of pods is greater than the count of a threshold set of pods. The computer-implemented method further includes controlling, by the computer, an instantiation of the threshold set of pods based on the determination that the count of the modified set of pods is greater than the count of the threshold set of pods.

In various embodiments of the disclosure, the computer-implemented method further includes controlling, by the computer, a routing of the set of real-time requests to the modified set of pods based on instantiation of the modified set of pods.

In various embodiments of the disclosure, the computer-implemented method further includes receiving, by the computer, the set of real-time requests for accessing the service. The computer-implemented method further includes generating, by the computer, a data structure for each real-time request of the set of real-time requests. The computer-implemented method further includes determining, by the computer, the count of the set of real-time requests for accessing the service based on the data structure for each real-time request of the set of real-time requests.

In various embodiments of the disclosure, the data structure for each real-time request of the set of real-time requests includes an identifier associated with the service and an identifier associated with a corresponding real-time request of the set of real-time requests.

In various embodiments of the disclosure, the computer-implemented method further includes associating, by the computer, a priority level with each real-time request of the received set of real-time requests based on at least one of priority data or historical data associated with the service. The computer-implemented method further includes modifying, by the computer, the data structure for each real-time request of the set of real-time requests based on the association. The modified data structure includes the priority level associated with the real-time request corresponding to the data structure.

In various embodiments of the disclosure, the computer-implemented method further includes routing, by the computer, the set of real-time requests to the modified set of pods based on the priority level associated with each real-time request of the set of real-time requests.

In various embodiments of the disclosure, the computer-implemented method further includes detecting, by the computer, the trigger associated with the scaling of the set of pods based on one or more trigger criteria. The one or more trigger criteria are associated with at least one of the count of the set of real-time requests, or a threshold time period associated with the scaling of the set of pods.

In various embodiments of the disclosure, the computer-implemented method further includes calculating, by the computer, the available request handling capacity value for each pod of the set of pods based on a maximum request handling capacity of a corresponding pod of the set of pods and a first subset of real-time requests of the set of real-time requests associated with the corresponding pod of the set of pods.

In various embodiments of the disclosure, a computer system for horizontal pod autoscaling based on real-time requests is described. The computer system includes a processor set, one or more computer-readable storage media, and program instructions stored on the one or more computer-readable storage media. The program instructions are executable by the processor set and cause the processor set to receive a set of real-time requests to access a service associated with an application. The set of pods implements a service provided by the application. The program instructions further cause the processor set to determine a count of a set of real-time requests to access the service. The program instructions further cause the processor set to obtain a health ratio value for each pod of the set of pods. The program instructions further cause the processor set to determine an available request handling capacity value for each pod of the set of pods. The program instructions further cause the processor set to determine an empirical coefficient value based on a set of metrics associated with the set of pods. The program instructions further cause the processor set to calculate a scaling coefficient based on the count of the set of real-time requests, the health ratio value, the available request handling capacity value, and the empirical coefficient value. The scaling coefficient is associated with a scaling of the set of pods. The program instructions further cause the processor set to modify the set of pods based on the calculated scaling coefficient and a count of the set of pods. The program instructions further cause the processor set to control an instantiation of the modified set of pods. The program instructions further cause the processor set to route the set of real-time requests to the modified set of pods based on the instantiation of the modified set of pods.

In various embodiments of the disclosure, the modification of the set of pods corresponds to an increase in the count of the set of pods associated with the application or a decrease in the count of the set of pods associated with the application.

In various embodiments of the disclosure, the program instructions further cause the processor set to determine that a count of the modified set of pods is greater than a count of a threshold set of pods. The program instructions further cause the processor set to control an instantiation of the threshold set of pods based on the determination that the count of the modified set of pods is greater than the count of the threshold set of pods.

In various embodiments of the disclosure, the program instructions further cause the processor set to generate a data structure for each real-time request of the received set of real-time requests. The program instructions further cause the processor set to determine the count of the set of real-time requests to access the service based on the data structure for each real-time request of the set of real-time requests.

In various embodiments of the disclosure, the data structure for each real-time request of the set of real-time requests includes an identifier associated with the service and an identifier associated with a corresponding real-time request of the set of real-time requests.

In various embodiments of the disclosure, the program instructions further cause the processor set to associate a priority level with each real-time request of the set of real-time requests based on at least one of priority data or historical data associated with the service. The program instructions further cause the processor set to modify the data structure for each real-time request of the set of real-time requests based on the association. The modified data structure includes the priority level associated with the real-time request corresponding to the data structure.

In various embodiments of the disclosure, the program instructions further cause the processor set to route the set of real-time requests to the modified set of pods based on the priority level associated with each real-time request of the set of real-time requests.

In various embodiments of the disclosure, the program instructions further cause the processor set to calculate the available request handling capacity value for each pod of the set of pods based on a maximum request handling capacity of a corresponding pod of the set of pods and a first subset of real-time requests of the set of real-time requests associated with the corresponding pod of the set of pods.

In various embodiments of the disclosure, a computer-program product to scale a set of pods implementing a service provided by an application is described. The computer program product includes one or more computer-readable storage media and program instructions stored in the one or more computer-readable storage media to perform operations that include detecting a trigger associated with a scaling of a set of pods associated with an application. The set of pods implements a service provided by the application. The operation further includes determining a count of a set of real-time requests for accessing the service of the application. The count of the set of real-time requests is determined based on the trigger. The operation further includes obtaining a health ratio value for each pod of the set of pods based on the trigger. The operation further includes determining an available request handling capacity value for each pod of the set of pods based on the trigger. The operation further includes determining an empirical coefficient value based on a set of metrics associated with the set of pods. The operation further includes calculating a scaling coefficient based on the count of the set of real-time requests, the health ratio value, the available request handling capacity value, and the empirical coefficient value. The scaling coefficient is associated with the scaling of the set of pods. The operation further includes modifying the set of pods based on the scaling coefficient and a count of the set of pods. The operation further includes controlling an instantiation of the modified set of pods.

In various embodiments of the disclosure, the modification of the set of pods corresponds to an increase in the count of the set of pods associated with the application or a decrease in the count of the set of pods associated with the application.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

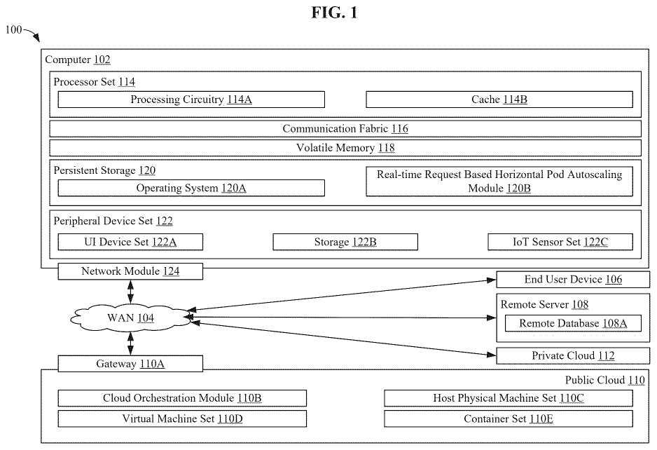

FIG. 1 is a diagram that illustrates a computing environment for prediction and prevention of cybersquatting events, in accordance with various embodiments of the disclosure. With reference to FIG. 1, there is shown a computing environment 100 that contains an example of an environment for the execution of at least some of the computer code involved in performing the disclosed methods, such as real-time request based horizontal pod autoscaling module 120B. In addition to the real-time request based horizontal pod autoscaling module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the real-time request based horizontal pod autoscaling module 120B, as identified above), a peripheral device set 122 (including a user interface (UI) device set 122A, a storage 122B, and an Internet of Things (IOT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any form of a computer or a mobile device now known or to be developed in the future that may run a program, access a network or query a database, such as a remote database 108A. As is well understood in the art of computer technology, and depending upon the technology, the performance of a computer-implemented method may be distributed among multiple computers and/or between multiple locations. Alternatively, in this presentation of the computing environment 100, detailed discussion is focused on a single computer, specifically the computer 102, to keep the presentation as simple as possible. The computer 102 may be located in a cloud, even though the computer 102 is not shown in a cloud in FIG. 1.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the storage media discussed below. The program instructions, and associated data, are accessed by the processor set 114 to control and direct the performance of the disclosed methods. In computing environment 100, at least some of the instructions for performing the disclosed methods may be stored in the dynamic modification of the real-time request based horizontal pod autoscaling module 120B in persistent storage 120.

The communication fabric 116 is the signal conduction path that allows the various components of computer 102 to communicate. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 may be characterized by random access. In the computer 102, the volatile memory 118 may be located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the real-time request based horizontal pod autoscaling module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 may include an amount of storage (for example, where computer 102 locally stores and manages a database) then this storage may be provided by peripheral storage devices designed for storing data, such as a storage area network (SAN) that is shared by multiple, geographically distributed computers. The IoT sensor set 122C is made up of sensors that may be used in Internet of Things applications. For example, one sensor may be a thermometer, and one sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods may typically be downloaded to computer 102 from an external computer or external storage device through a network adapter card or network interface included in the network module 124.

The WAN 104 is any wide area network (for example, the internet) that communicates computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collects and stores helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. Virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each cloud of the multiple clouds remains a separate and discrete entity, but the r hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a hybrid cloud.

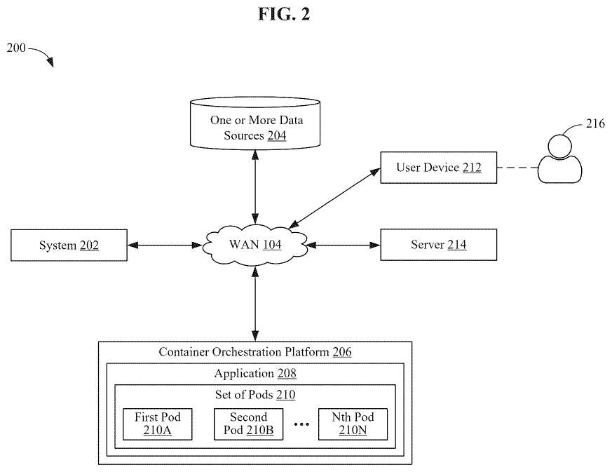

FIG. 2 is a diagram that illustrates a network environment 200 for horizontal pod autoscaling based on real-time requests, in accordance with various embodiments of the disclosure. FIG. 2 is explained in conjunction with elements from FIG. 1. With reference to FIG. 2, there is shown a diagram of a network environment 200. The network environment 200 includes a system 202, one or more data sources 204, and a container orchestration platform 206 hosting an application 208 (also referred to as a container application). The application 208 may be hosted on a set of pods 210. The set of pods 210 further includes a first pod 210A, a second pod 210B, and up to an Nth pod 210N. The network environment 200 further includes a user device 212, a server 214, and an entity 216 that may be associated with the user device 212. In various embodiments of the disclosure, the user device 212 may be an exemplary embodiment of the EUD 106. Similarly, the system 202 may be an exemplary embodiment of the computer 102 in FIG. 1.

The system 202 may include suitable logic, circuitry, interfaces, and/or code that may be configured for horizontal pod autoscaling based on real-time request rate. The system 202 may be configured to detect a trigger associated with a scaling of the set of pods associated with an application. The set of pods implements a service provided by the application 208. The system may be further configured to determine a count of a set of real-time requests for accessing a service of the application 208. The count of the set of real-time requests is determined based on the trigger The system 202 may be further configured to obtain a health ratio value for each pod of the set of pods 210 based on the detected trigger. The system 202 may be further configured to determine an available request handling capacity value for each pod of the set of pods 210 based on the detected trigger. The system 202 may be further configured to determine an empirical coefficient value based on a set of metrics associated with the set of pods 210. The system 202 may be further configured to calculate a scaling coefficient based on the count of the set of real-time requests, the health ratio value, the available request handling capacity value, and the empirical coefficient value. The system 202 may be further configured to modify the set of pods 210 based on the scaling coefficient and a count of the set of pods. The system 202 may be further configured to control an instantiation of the modified set of pods. Examples of the system 202 may include, but are not limited to, a server, a computing device, a virtual computing device, a mainframe machine, a computer workstation, a smartphone, a cellular phone, a mobile phone, a gaming device, or a consumer electronic (CE) device.

Each database of the one or more data sources 204 may correspond to an organized collection of data that may be stored and accessed electronically from a computer system (such as the system 202). Each data source of the one or more data sources 204 may be designed to manage, store, retrieve, and update data efficiently. In an exemplary implementation, each data source of the one or more data sources 204 may correspond to a database. In such an implementation, the database corresponding to each data source of the one or more data sources 204 typically stores historical data based on which a priority is associated with each real-time request of the set of real-time requests.

The container orchestration platform 206 includes suitable logic, circuitry, interfaces, and/or code that may be configured to host the application 208. Generally, the container orchestration platform 206 is a software framework that enables the deployment, management, and scaling of the containerized application 208. The container orchestration platform 206 provides a consistent runtime environment by encapsulating the application 208 and the dependencies of the application 208 within containers, ensuring seamless operation across various computing environments. These platforms offer tools and services for orchestrating containers, optimizing resource utilization, and automating tasks such as scaling and fault tolerance. Examples of different types of container orchestration platform 206 include but are not limited to, container engines (such as docker®), container orchestrators (such as Kubernetes® and OpenShift®), and managed container orchestration platforms.

In an embodiment of the disclosure, the application 208 is hosted on the container orchestration platform 206. Specifically, hosting the application 208 on the container orchestration platform 206 involves several key phases to ensure it runs efficiently and reliably. Firstly, a docker file is created to define the environment of the application 208, dependencies, and relevant instructions to build the application image. The application image is then pushed to a container registry. Further, deployment configurations, typically using Yet Another Markup Language (YAML) files, are crafted to define the desired state of the application 208, specifying details such as the number of replicas, resource limits, and networking requirements. Such configurations are applied using container orchestration tools like Kubernetes®, which manage the deployment, scaling, and operation of the application containers across a cluster of nodes. Additional configurations might include setting up persistent storage, configuring environment variables and secrets for sensitive data, and setting up monitoring and logging to track the performance and the health of the application 208.

The set of pods 210 may be associated with the system 202 including the first pod 210A, the second pod 210B up to Nth pod 210N. The set of pods 210 includes a total of ‘N’ number of pods. The ‘N’ represents an integer value. Each pod of the set of pods 210 is a computing unit that may be created and managed in container orchestration platform 206. A Pod is a group of one or more containers, with shared storage and network resources, and a specification for how to run the containers. The containers are executable units that encapsulate the application 208 and its dependencies, ensuring consistent performance across various environments. Each Pod is meant to run a single instance of a given service provided by the application 208.

The user device 212 may include suitable logic, circuitry, interfaces, and/or code that may be configured to display an interface of the application 208 to the entity 216. The interface allows the user to interact with the application 208. In various embodiments, the entity 216 may correspond to a stand-alone user or an organization. Examples of the user device 212 may include, but are not limited to, a computing device, a mainframe machine, a server, a computer work-station, a smartphone, a cellular phone, a mobile phone, a gaming device, a consumer electronic (CE) device, a head-mounted device, a virtual reality (VR) headset, an augmented reality (AR) Device, a mixed reality (MR) Device, a projection-based system, and/or any device with computer vision display capabilities.

The server 214 may include suitable logic, circuitry, interfaces, and/or code that stores the count of a set of real-time requests, the health ratio value for each pod of the set of pods, the available request handling capacity, the empirical coefficient value, and the scaling coefficient. The server 214 may be implemented as a cloud server and may execute operations through web applications, cloud applications, hypertext transfer protocol (HTTP) requests, repository operations, file transfer, and the like. Various example implementations of the server 214 may include but are not limited to, a database server, a file server, a web server, a media server, an application server, a mainframe server, or a cloud computing server.

In an embodiment of the disclosure, the server 214 is implemented as a plurality of cloud-based resources distributed by the use of several technologies that are well known to those ordinarily skilled in the art. A person with ordinary skill in the art will understand that the scope of the disclosure may not be limited to the implementation of the server 214 and the system 202 as two separate entities. In certain embodiments, the functionalities of the server 214 can be incorporated in its entirety or at least partially in the system 202, without a departure from the scope of the disclosure.

In operation, the system 202 detects a trigger associated with the scaling of the set of pods 210. The set of pods implements at least one service provided by the application 208. The service corresponds to a specific function provided by the application 208, typically accessible through an interface (such as an application programming interface (API)). Examples of services may include data processing, user authentication, transaction management, or the like.

The system 202 determines the count of the set of real-time requests for accessing the service of the application 208. The count of the real-time requests is determined based on the detection of the trigger. The system 202 obtains the health ratio value for each pod of the set of pods 210. Further, the system 202 determines the available request handling capacity value for each pod of the set of pods 210. The system 202 determines the empirical coefficient value based on a set of metrics associated with the set of pods 210. In an embodiment, the set of metrics may correspond to a set of resource metrics, and a set of custom metrics. The system 202 further calculates the scaling coefficient. The scaling coefficient is calculated based on the count of the set of real-time requests, the health ratio value, the available request handling capacity value, and the empirical coefficient value. The scaling coefficient is associated with the scaling of the set of pods 210. In an embodiment, the scaling of the set of pods 210 may correspond to the scaling up of the set of pods. The scaling up of the set of pods 210 corresponds to an increase in the set of pods 210. In an alternate embodiment, the scaling of the set of pods 210 may correspond to the scaling down of the set of pods. The scaling down of the set of pods 210 corresponds to a decrease in the set of pods 210. The system 202 modifies the set of pods 210. based on the scaling coefficient and a count of the set of pods. The modification of the set of pods corresponds to one of the increases in the set of pods 210 or the decrease in the set of pods 210. The system 202 controls the instantiation of the modified set of pods.

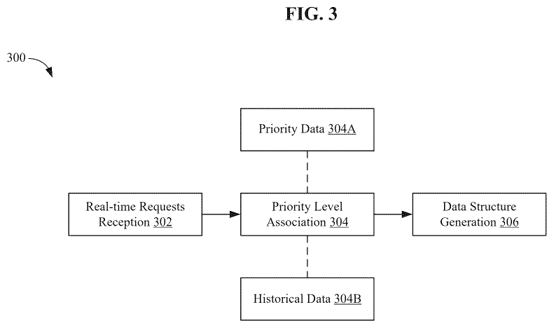

FIG. 3 is a diagram that illustrates exemplary operations for the generation of a data structure for horizontal pod autoscaling based on real-time request rate, in accordance with various embodiments of the disclosure. FIG. 3 is explained in conjunction with elements from FIG. 1, and FIG. 2. With reference to FIG. 3, there is shown a block diagram 300 that illustrates exemplary operations from 302 to 306, as described herein. The exemplary operations illustrated in the block diagram 300 may start at 302 and may be performed by any computing system, apparatus, or device, such as by the computer 102 of FIG. 1 or system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a real-time requests reception operation is executed. In the real-time requests reception operation, the system 202 may be configured to receive a set of real-time requests. In various embodiments, each real-time request of the set of real-time requests may be received from user device 212 and may be associated with the entity 216. Each request of the set of real-time requests may be received for accessing the service of the application 208.

Specifically, the application 208 is hosted on container orchestration platform 206 are software solutions that run in isolated environments known as containers, which package the application code along with its dependencies, libraries, and configuration files. This encapsulation allows the application 208 to operate consistently across various computing environments, enhancing portability and scalability. For example, a banking application might provide a fund transfer service, enabling users to send money between accounts securely and efficiently. Various examples may include, but are not limited to, an e-commerce application offering services like product browsing and order processing, or a healthcare application delivering patient management services.

At 304, a priority level association operation may be executed. In the priority level association operation, the system 202 may be configured to associate a priority level to each real-time request of the set of real-time requests that may be received for accessing the service provided by the application 208. In various embodiments, the priority level assigned to a corresponding real-time request of the set of real-time requests may be a numerical value that represents a preference given to the corresponding real-time request over the remaining real-time requests of the set of real-time requests for processing (or handling) by the set of pods 210.

In various embodiments, the system 202 may be configured to associate a priority level with each real-time request of the set of real-time requests that may be received for accessing the service that may be provided by the application 208. In various embodiments, the priority data 304A may correspond to a set of priority levels provided by the entity 216 for each real-time request of the set of real-time requests as per the preference of the entity 216. Specifically, the system 202 may receive the priority data 304A from an administrator of the application 208. In an embodiment, the system 202 may be configured to associate the priority level with each real-time request of the set of real-time requests based on the time of reception of the corresponding real-time request of the set of real-time requests. For example, the system 202 receives a first real-time request of the set of real-time requests at a first time (e.g., 13:57:22) and the system 202 receives a second real-time request of the set of real-time requests at a second time (e.g., 13:58:12), then the system 202 may be configured to assign a higher priority to the first real-time request than the second real-time request.

In various embodiments, the system 202 may be configured to associate a priority level to each real-time request of the set of real-time requests accessing the service provided by the application 208 based on the historical data 304B. The historical data 304B may be indicative of priority levels that may be assigned to a set of historical real-time requests. Based on the analysis of the historical data 304B, the system 202 may assign the priority level to each request to the set of real-time requests. In an embodiment, the system 202 may be configured to assign the priority level to each real-time request of the set of real-time requests based on a source (or an origin) of a corresponding real-time request frequency of requests for the service, an end-user associated with the corresponding real-time request frequency of requests for the service peak usage time of the service, a count of historical user interactions with the service, response time for the corresponding real-time request, or the like. For example, if the application 208 provided banking services, then a request from a customer who might have opted for a premium plan may be assigned with a higher priority level than a request that may be received from a normal customer. In an embodiment, the system 202 may be configured to associate the priority level using one or more machine learning models.

It may be noted that the disclosure may not be limited to the assignment of the priority level to each real-time request of the set of real-time requests based on the above-mentioned parameters and using the above-mentioned processes. The system 202 may be configured to assign the priority level to each real-time request of the set of real-time requests based on parameters and using processes that are known in the art without deviation from the scope of the disclosure.

At 306, a data structure generation operation may be executed. In the data generation operation, the system 202 may be configured to generate the data structure. In various embodiments, the system 202 may be configured to generate the data structure for each real-time request of the set of real-time requests that may be received for accessing the service provided by the application 208. The data structure may correspond to a specific format for organizing, processing, retrieving, updating, and storing data in the system 202. The generated data structure may include a real-time request identifier, a service identifier, and the priority level assigned to the corresponding real-time request. The format of the data structure may be as follows:
Request Identifier: Service Identifier: Priority Level

By way of example, not by limitation, the data structure for the set of real-time requests accessing the service A, service B, service C, and service F provided by the application 208 may be represented as follows:

{
“request 1”: “service A”:1,
“request 2”: “service A”:1,
“request 3”: “service A”:1,
“request 4”: “service A”:5,
“request 5”: “service B”:4,
“request 6”: “service B”:4,
“request 7”: “service C”:3,
“request 8”: “service C”:3,
...
“request 200”: “service A”:2,
“request 201”: “service F”:1,
...
}

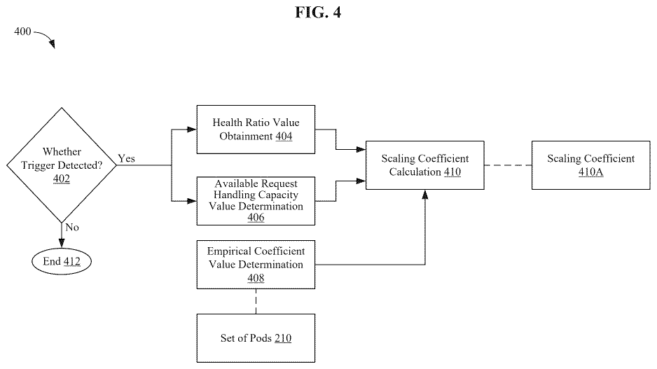

The system 202 may be further configured to store the data structure. The system 202 may be further configured to modify the set of pods 210 based on the generated data structure as described below in FIG. 4.

FIG. 4 is a diagram that illustrates exemplary operations for the calculation of a scaling coefficient for horizontal pod autoscaling based on real-time request rate, in accordance with various embodiments of the disclosure. FIG. 4 is explained in conjunction with elements from FIG. 1, FIG. 2, and FIG. 3. With reference to FIG. 4, there is shown a block diagram 400 that illustrates exemplary operations from 402 to 412, as described herein. The exemplary operations illustrated in the block diagram 400 may start at 402 and may be performed by any computing system, apparatus, or device, such as by the computer 102 of FIG. 1 or system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, it may be determined if the trigger is detected. In various embodiments, the system 202 may be configured to detect a trigger based on one or more trigger criteria. The one or more criteria may be associated with at least one of the count of the set of real-time requests that may be received for accessing the service, or a threshold time period associated with the scaling of the set of pods 210 (specifically a previous scaling of the set of pods). In case the system 202 may detect the trigger, then the system 202 may be configured to proceed to operation 404. In case the trigger is not detected, the system 202 may be configured to proceed to end at 412.

In various embodiments, the system 202 may be configured to detect a trigger based on the count of the set of real-time requests accessing the service. Specifically, the system 202 may be configured to determine if the count of the set of real-time requests exceeds a threshold count. In case the count of the set of real-time requests exceeds the threshold count, the trigger may be detected. The threshold count may correspond to a maximum count of real-time requests that the set of pods 210 can handle (or process). For example, if the threshold count is 5000, and the count of real-time requests is 5062, then the trigger may be detected.

In an alternate embodiment, the system 202 may be configured to detect the trigger based on the threshold time period associated with the scaling of the set of pods. Specifically, the system 202 may be configured to detect the trigger after the threshold time period from a previous instance when the system 202 scaled the set of pods 210. In an embodiment, if a difference between a current instance and the previous instance is greater than the threshold time period, then the trigger is detected. By way of an example, and not by limitation, if the threshold time period is 5milliseconds, and the difference between the previous instance and the current instance is 6milliseconds, then the trigger is detected.

At 404, a health ratio value obtainment operation is executed. In the health ratio value obtainment operation, the system 202 may be configured to obtain the health ratio value for each pod of the set of pods 210 implementing the service provided by the application 208 based on the trigger detected at 402. In an alternate embodiment, the system 202 may be configured to obtain the health ratio value for each pod of the set of pods 210 implementing the service provided by the application 208 based on the generated data structure for each real-time request of the set of real-time requests. In various embodiments, the health ratio value associated with a pod of the set of pods 210 implementing the service may correspond to a quantitative measure of the operational health and performance of the pod of the set of pods 210 within the container orchestration environment.

In various embodiments, the health ratio value for each pod of the set of pods 210 may be determined based on the total request handling capacity of the corresponding pod, and the optimum request handling capacity of the corresponding pod. Specifically, the optimum request handling capacity may be indicative of the number of requests that the corresponding pod may be able to handle without dropping even a single request. For example, if the total request handling capacity of a pod is 1000 and the optimum request handling capacity of the pod is 700, then the health ration value is 0.7 (or 70%).

At 406, an available request handling capacity value determination operation is executed. In the available request handling capacity value determination operation, the system 202 may determine the available request handling capacity value for each pod of the set of pods 210 based on the trigger detected at 402. In various embodiments, the available request handling capacity value may correspond to the maximum number of requests that the pod can process at a given time, considering the current number of requests being handled by the corresponding pod.

In various embodiments, the system 202 may be configured to determine the available request handling capacity value for each pod of the set of pods 210 based on the maximum number of requests that the pod can process at the given time, and the current number of requests being handled by the corresponding pod. By way of example, not by limitation, the available request handling capacity value for the pod based may be calculated using the equation (1) as follows:

$${C}_{i} = {( Maximum request handling capacity )}_{i} - {( Current Requests )}_{i} \qquad ( 1 )$$

where,
Cᵢ corresponds to the available request handling capacity value for pod “i”,
(Maximum request handling capacity); corresponds to the maximum number of requests that the pod “i” can process at the given time, and
(Current Requests); corresponds to the current number of requests being handled by the pod “i”.

By way of example, not by limitation, if the maximum request handling capacity is 1000 requests and the count of the set of real-time requests is 997, then the available request handling capacity value for the pod may be “3” which may be calculated using equation (1).

At 408, an empirical coefficient value determination operation is executed. In the empirical coefficient value determination operation, the system 202 may determine the empirical coefficient value based on a set of metrics associated with each pod of the set of pods 210. In an embodiment, the system 202 may utilize the set of metrics associated with each pod of the set of pods 210 to determine the empirical coefficient value. By way of example, and not by limitation, the set of metrics may include a CPU utilization metric by each pod of the set of pods, a memory utilization by each pod of the set of pods 210, or various custom metrics (such as request rate of the application 208, latency of the application 208, the application-specific metrics or the like) associated with each pod of the set of pods 210.

At 410, a scaling coefficient calculation operation is executed. In the scaling coefficient calculation operation, the system 202 may calculate the scaling coefficient 410A. The scaling coefficient 410A is associated with the scaling of pods. In an embodiment, the scaling of the set of pods in Kubernetes refers to the process of modifying the set of pods 210 (also referred to as pod replicas) to fulfill the received set of real-time requests. In an embodiment, the scaling of the set of pods 210 may correspond to an upscaling of the set of pods 210. In the upscaling of the set of pods 210, the number of pods in the set of pods 210 may be increased to handle higher workloads or traffic, thereby ensuring that the application 208 remains responsive and available. In an alternate embodiment, the scaling of the set of pods 210 may correspond to the downscaling of the set of pods 210. In the downscaling of the set of pods 210, the number of pods in the set of pods 210 may be reduced, thereby optimizing resource usage and reducing costs.

In an embodiment, the system 202 may be configured to calculate the scaling coefficient based on the count of the set of real-time requests, the health ratio value for each pod of the set of pods 210, the available request handling capacity value of each pod of the set of pods 210, and the empirical coefficient value. In an embodiment, the scaling coefficient 410A associated with the scaling of the set of pods 210 may be calculated by equation (2) as follows:

$$X = \frac{a + b}{( {\sum }_{i = 1}^{n} {h}_{i} {c}_{i} )} \qquad ( 2 )$$

where
X corresponds to the scaling coefficient,
a corresponds to the count of the set of real-time requests that may be received for accessing the service of the application 208,
b corresponds to the empirical coefficient value,
n corresponds to the count of the set of pods 210,
hᵢ corresponds to the health ratio value of pod “i” of the set of pods 210, and
cᵢ represents the available request handling capacity value of pod “i” of the set of pods 210.

By way of example, not by limitation, if the count of real-time requests is 3, the empirical coefficient is 3.2, the count of the set of pods 210 is 3 (say is P₁, P₂, P₃), the health ratio value for P₁ (also referred to h₁) is 0.9, the health ratio value for P₂ (also referred to h₂) is 0.8, the health ratio value for P₃ (also referred to h₃) is 0.85, the available request handling capacity value for P₁ (also referred as to C₁) is 2, the available request handling capacity value for P₂ (also referred as to C₂) is 1, and the available request handling capacity value for P₃ (also referred as to C₃) is 1, then the scaling coefficient associated with the scaling of the set of pods 210 may be calculated using the equation (2) and represented by equation (3) as follows:

$$X = \frac{4 + 3.2}{( 2 \times 0.9 + 1 \times 0.8 + 1 \times 0.85 )} = 2.0869 \qquad ( 3 )$$

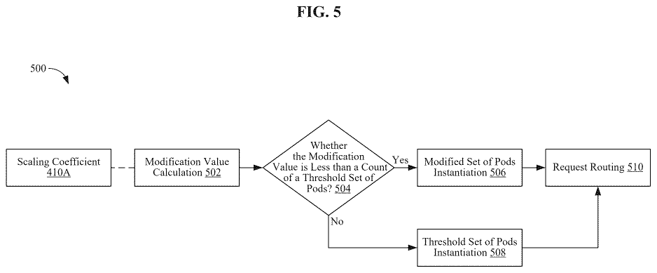

It may be noted that if the value of the scaling coefficient is between 0 and 1, then the set of pods 210 may be downscaled, and if the value of the scaling coefficient is between 1, then the set of pods 210 may be upscaled. In case the value of the scaling coefficient is 1, then the set of pods 210 may not be scaled. Details about the scaling of the set of pods 210 are provided, for example, in FIG. 5.

FIG. 5 is a diagram that illustrates exemplary operations for modification of a set of pods for horizontal pod autoscaling based on real-time request rate, in accordance with various embodiments of the disclosure. FIG. 5 is explained in conjunction with elements from FIG. 1, FIG. 2, FIG. 3, and FIG. 4. With reference to FIG. 5, there is shown a block diagram 500 that illustrates exemplary operations from 502 to 510, as described herein. The exemplary operations illustrated in the block diagram 500 may start at 502 and may be performed by any computing system, apparatus, or device, such as by the computer 102 of FIG. 1 or the system 202 of FIG. 2. Although illustrated with discrete blocks, the exemplary operations associated with one or more blocks of the block diagram 500 may be divided into additional blocks, combined into fewer blocks, or eliminated, depending on the particular implementation.

At 502, a modification value calculation operation is executed. In the modification value calculation operation, the system 202 may calculate a modification value for the modification of the set of pods 210. The modification value may be indicative of a count of the set of pods 210 after the modification of the set of pods 210. In an embodiment, the system 202 may be configured to calculate the modification value based on the scaling coefficient 410A and the count of the set of pods 210 implementing the service. The system 202 may be configured to calculate the modified set of pods by the equation (4) as follows:

$$Z = X \times Y \qquad ( 4 )$$

### Where,

Z corresponds to the modification value,
X corresponds to the scaling coefficient 410A, and
Y corresponds to the count of the set of pods 210.

As an example, if the count of the set of pods 210 is 4 and the scaling coefficient 410A is 2.0869 (as calculated at 410), then the modification value calculated using equation (4) may be 8.3476. It may be noted that the modification value may be a numerical value. In an embodiment, where the modification value is rational, then the system 202 may be configured to apply a rounding function (e.g., a floor function or a ceiling function) to round off the rational value to a whole value. The floor function is a mathematical function that rounds a given real number down to the nearest integer less than or equal to that number. The ceiling function is a mathematical function that rounds a given real number up to the nearest integer greater than or equal to that number. In case the scaling coefficient may be a whole value, the system 202 may not apply the rounding function.

By way of example, not by limitation, the system 202 may apply the floor function to round off the rational value of modification value ‘Z’ calculated using equation (4). The floor function may be applied to the modification value ‘Z’ as represented by equation (5) as follows:

$${Z}^{′} = floor ( Z ) = floor ( 8.3476 ) = 8 \qquad ( 5 )$$

The modification value being “8” indicates that the count of the modified set of pods may be 8 or the set of pods 210 may be increased from 4 to 8. As an example, if the count of the set of pods 210 is 4 and the scaling coefficient 410A is 0.5 (as calculated at 410), then the modification value calculated using the equation (4) may be 2. In such a case, the system 202 may not apply the rounding function. The modification value being “2” indicates that the count of the modified set of pods may be 2 or the set of pods 210 may be decreased from 4 to 2.

At 504, it may be determined whether the modification value is less than a count of a threshold set of pods. In an embodiment, the system 202 may be configured to compare the modification value with the count of the threshold set of pods. In various embodiments, the threshold set of pods may correspond to a maximum number of pods that can implement the service provided by the application 208. In an embodiment, the threshold set of pods may specified by the administrator of the application 208. In an alternate embodiment, the system 202 may automatically determine the threshold set of pods based on the availability of the pods within the container orchestration platform 206. In an alternate embodiment, the system 202 may automatically determine the threshold set of pods based on a maximum cost that the administrator may pay to the container orchestration platform 206 for hosting the application 208 on the container orchestration platform 206. In an embodiment, such maximum cost may be specified by the administrator of the application 208.

At 506, a modified set of pods instantiation operation is executed. In the modified set of pods instantiation operation, the system 202 may instantiate a modified set of pods based on the determination that the modification value is less than the count of the threshold set of pods. In an embodiment, a count of the set of pods after the modification may be equal to the modification value ‘Z’. In an embodiment, the set of pods may be modified based on the determination that the modification value is less than the count of the threshold set of pods. In such a scenario, the number of pods in the modified set of pods may be equal to the modification value ‘Z’. For example, if the modification value ‘Z’ is 8, then the count of the modified set of pods may be 8 and if the modification value ‘Z’ is 2, then the count of the modified set of pods may be 8.

The system 202 may be further configured to control an instantiation of the modified set of pods. Specifically, if the count of the modified set of pods is greater than the set of pods, then controlling the instantiation of the modified set of pods may correspond to creating and configuring new pods that may provide the service associated with the application 208. For example, if the count of the modified set of pods is 8, and the count of the set of pods maybe 4, then the system 202 may create and configure 4 additional pods.

In an alternate embodiment, if the count of the modified set of pods is less than the set of pods, then the controlling of the instantiation of the modified set of pods may correspond to the deletion of additional pods that may be present in the set of pods. For example, if the count of the modified set of pods is 2, and the count of the set of pods may be 4, then the system 202 may delete 2 pods.

At 508, a threshold set of pods instantiation operation is executed. In the threshold set of pods instantiation operation, the system 202 may control the instantiation of the threshold set of pods based on the determination that the modification value is greater than the threshold set of pods. Controlling the instantiation of the threshold set of pods may correspond to creating and configuring new pods that may provide the service associated with the application 208. For example, if the count of the modified set of pods is 8, the count of the set of pods may be 4, and the threshold set of pods is 6, then the system 202 may create and configure 2 additional pods.

At 510, a request routing operation may be executed. In the request routing operation, the system 202 may route the set of real-time requests (or upcoming real-time requests) to the modified set of pods or the threshold set of pods based on the instantiation of the modified set of pods or the threshold set of pods respectively. In an embodiment, the system 202 may route the set of real-time requests (or upcoming real-time requests) to the modified set of pods based on the determination that the modification value is less than the threshold set of pods. In an alternate embodiment, the system 202 may route the set of upcoming real-time requests to the threshold set of pods based on the determination that the modification value is greater than the count of the threshold set of pods. In an embodiment, the system 202 may be configured to route the real-time request to the modified set of pods or the threshold set of pods based on the priority level associated with the corresponding real-time request. For example, a first real-time request with a higher priority level than a second real-time request may be routed to a pod from the modified set of pods or the threshold set of pods.

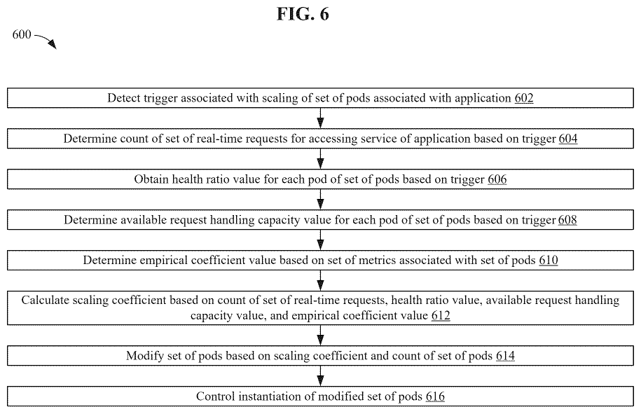

FIG. 6 is a diagram that illustrates a flowchart of an exemplary first method for horizontal pod autoscaling based on real-time request rate, in accordance with various embodiments of the disclosure. FIG. 6 is explained in conjunction with elements from FIG. 1, FIG. 2, FIG. 3, FIG. 4, and FIG. 5. With reference to FIG. 6, there is shown a flowchart 600. The operations of the exemplary method may be executed by any computing system, for example, by the computer 102 of FIG. 1 or the system 202 of FIG. 2. The operations of the flowchart 600 may start at 602.

At 602, the trigger associated with the scaling of the set of pods 210 associated with the application 208 is detected. The set of pods 210 implements the service provided by the application 208. In various embodiments, the system 202 detects the trigger associated with the scaling of the set of pods 210 associated with the application 208, wherein the set of pods 210 implements the service provided by the application 208. Details about the detection of the trigger are provided, for example, at 402 in FIG. 4.

At 604, the count of the set of real-time requests for accessing the service of the application 208 is determined. The count of the set of real-time requests is determined based on the trigger. In various embodiments, the system 202 determines the count of the set of real-time requests for accessing the service of the application 208, wherein the count of the set of real-time requests is determined based on the trigger.

At 606, the health ratio value for each pod of the set of pods is obtained based on the trigger. In various embodiments, the system 202 obtains the health ratio value for each pod of the set of pods 210 based on the trigger. Details about the health ratio value are provided, for example, in FIG. 4.

At 608, the available request handling capacity value for each pod of the set of pods 210 is determined. In various embodiments, the system 202 determines the available request handling capacity value for each pod of the set of pods 210 based on the trigger. Details about the determination of the available request handling capacity value operations are provided, for example, in FIG. 4.

At 610, the empirical coefficient value is determined. In various embodiments, the system determines the empirical coefficient value based on the set of metrics associated with the set of pods 210. Details about the empirical coefficient value determination operation are provided, for example, in FIG. 4.

At 612, the scaling coefficient is calculated value based on the set of metrics associated with the set of pods 210 based on the count of the set of real-time requests, the health ratio value, the available request handling capacity value, and the empirical coefficient value. In various embodiments, the system 202 calculates the scaling coefficient based on the count of the set of real-time requests, the health ratio value, the available request handling capacity value, and the empirical coefficient value. The scaling coefficient is associated with the scaling of the set of pods 210. Details about the calculation of the scaling coefficient are provided, for example, in FIG. 4.

At 614, the set of pods is modified based on the scaling coefficient and a count of the set of pods. In various embodiments, the system 202 may be configured to modify the set of pods 210 based on the scaling coefficient calculated and the count of the set of real-time requests. Details about the modification of the set of pods 210 are provided, for example, in FIG. 5.

At 616, the instantiation of the modified set of pods is controlled. In various embodiments, the system 202 controls the instantiation of the modified set of pods based on the modification of the set of pods 210. Details about the instantiation of the set of pods 210 are provided, for example, in FIG. 5.

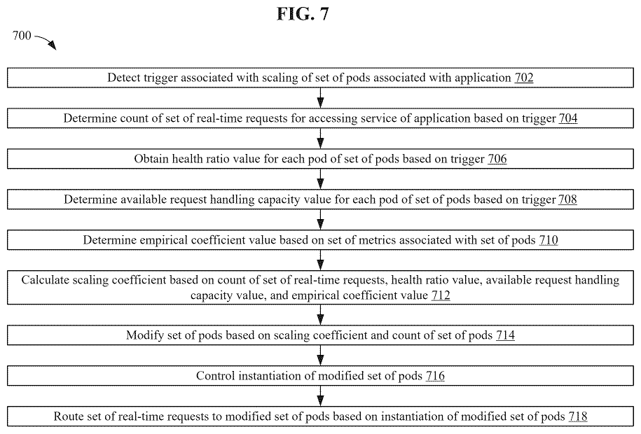

FIG. 7 is a diagram that illustrates a flowchart of a second exemplary method for horizontal pod autoscaling based on real-time request rate, in accordance with an embodiment of the disclosure, in accordance with various embodiments of the disclosure. FIG. 7 is explained in conjunction with elements from FIG. 1, FIG. 2, FIG. 3, FIG. 4, FIG. 5, and FIG. 6. With reference to FIG. 7, there is shown a flowchart 700. The operations of the exemplary method may be executed by any computing system, for example, by the computer 102 of FIG. 1 or the system 202 of FIG. 2. The operations of the flowchart 700 may start at 702.

At 702, the trigger associated with the scaling of the set of pods 210 associated with the application 208 is detected. The set of pods 210 implements the service provided by the application 208. In various embodiments, the system 202 detects the trigger associated with the scaling of the set of pods 210 associated with the application, wherein the set of pods 210 implements the service provided by the application 208. Details about the detection of the trigger are provided, for example, at 402 in FIG. 4.

At 704, the count of the set of real-time requests for accessing the service of the application 208 is determined. The count of the set of real-time requests is determined based on the trigger. In various embodiments, the system 202 determines the count of the set of real-time requests for accessing the service of the application 208, wherein the count of the set of real-time requests is determined based on the trigger.

At 706, the health ratio value for each pod of the set of pods 210 is obtained based on the trigger. In various embodiments, the system 202 obtains the health ratio value for each pod of the set of pods 210 based on the trigger. Details about the health ratio value are provided, for example, in FIG. 4.

At 708, the available request handling capacity value for each pod of the set of pods 210 is determined. In various embodiments, the system 202 determines the available request handling capacity value for each pod of the set of pods 210 based on the trigger. Details about the determination of the available request handling capacity value operations are provided, for example, in FIG. 4.

At 710, the empirical coefficient value is determined. In various embodiments, the system determines the empirical coefficient value based on the set of metrics associated with the set of pods. Details about the empirical coefficient value determination operation are provided, for example, in FIG. 4.

At 712, the scaling coefficient is calculated value based on the set of metrics associated with the set of pods 210 based on the count of the set of real-time requests, the health ratio value, the available request handling capacity value, and the empirical coefficient value. In various embodiments, the system 202 calculates the scaling coefficient based on the count of the set of real-time requests, the health ratio value, the available request handling capacity value, and the empirical coefficient value. The scaling coefficient is associated with the scaling of the set of pods 210. Details about the calculation of the scaling coefficient are provided, for example, in FIG. 4.

At 714, the set of pods 210 is modified based on the scaling coefficient and a count of the set of pods 210. In various embodiments, the system 202 may be configured to modify the set of pods 210 based on the scaling coefficient calculated and the count of the set of real-time requests. Details about the modification of the set of pods 210 are provided, for example, in FIG. 5.

At 716, the instantiation of the modified set of pods is controlled. In various embodiments, the system 202 controls the instantiation of the modified set of pods based on the modification of the set of pods 210. Details about the instantiation of the set of pods 210 operations are provided, for example, in FIG. 5.

At 718, the set of real-time requests is routed to the modified set of pods The routing of the set of real-time requests to the modified set of pods is based on the instantiation of the modified set of pods. In various embodiments, the system routes the set of real-time requests to the modified set of pods based on the instantiation of the modified set of pods. Details about the routing of the set of real-time requests are provided, for example, in FIG. 5.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
detecting, by a computer, a trigger associated with a scaling of a set of pods associated with an application, wherein the set of pods implements a service provided by the application;
determining, by the computer, a count of a set of real-time requests for accessing the service of the application, wherein the count of the set of real-time requests is determined based on the trigger;
obtaining, by the computer, a health ratio value for each pod of the set of pods based on the trigger;
determining, by the computer, an available request handling capacity value for each pod of the set of pods based on the trigger;
determining, by the computer, an empirical coefficient value based on a set of metrics associated with the set of pods;
calculating, by the computer, a scaling coefficient based on the count of the set of real-time requests, the health ratio value, the available request handling capacity value, and the empirical coefficient value, wherein the scaling coefficient is associated with the scaling of the set of pods;
modifying, by the computer, the set of pods based on the scaling coefficient and a count of the set of pods; and
controlling, by the computer, an instantiation of the modified set of pods.

2. The computer-implemented method of claim 1, wherein the modification of the set of pods corresponds to an increase in the count of the set of pods associated with the application or a decrease in the count of the set of pods associated with the application.

3. The computer-implemented method of claim 1, further comprising:
determining, by the computer, that a count of the modified set of pods is greater than a count of a threshold set of pods; and
controlling, by the computer, the instantiation of the threshold set of pods based on the determination that the count of the modified set of pods is greater than the count of the threshold set of pods.

4. The computer-implemented method of claim 1, further comprising:
controlling, by the computer, a routing of the set of real-time requests to the modified set of pods based on the instantiation of the modified set of pods.

5. The computer-implemented method of claim 1, further comprising:
receiving, by the computer, the set of real-time requests for accessing the service;
generating, by the computer, a data structure for each real-time request of the received set of real-time requests; and
determining, by the computer, the count of the set of real-time requests for accessing the service based on the data structure for each real-time request of the set of real-time requests.

6. The computer-implemented method of claim 5, wherein the data structure for each real-time request of the set of real-time requests comprises an identifier associated with the service and an identifier associated with a corresponding real-time request of the set of real-time requests.

7. The computer-implemented method of claim 5, further comprising:
associating, by the computer, a priority level with each real-time request of the received set of real-time requests based on at least one of priority data or historical data associated with the service; and
modifying, by the computer, the data structure for each real-time request of the set of real-time requests based on the association, wherein the modified data structure comprises the priority level associated with the real-time request corresponding to the data structure.

8. The computer-implemented method of claim 7, further comprising:
routing, by the computer, the set of real-time requests to the modified set of pods based on the priority level associated with each real-time request of the set of real-time requests.

9. The computer-implemented method of claim 1, further comprising:
detecting, by the computer, the trigger associated with the scaling of the set of pods based on one or more trigger criteria, wherein the one or more trigger criteria is associated with at least one of the count of the set of real-time requests, or a threshold time period associated with the scaling of the set of pods.

10. The computer-implemented method of claim 1, further comprising:
calculating, by the computer, the available request handling capacity value for each pod of the set of pods based on a maximum request handling capacity of a corresponding pod of the set of pods and a first subset of real-time requests of the set of real-time requests associated with the corresponding pod of the set of pods.

11. A computer system, comprising:
a processor set;
one or more computer-readable storage media; and
program instructions stored on the one or more computer-readable storage media, the program instructions executable by the processor set to cause the processor set to:
receive a set of real-time requests to access a service associated with an application, wherein the set of pods implements the service provided by the application;
determine a count of the set of real-time requests to access the service;
obtain a health ratio value for each pod of the set of pods;
determine an available request handling capacity value for each pod of the set of pods;
determine an empirical coefficient value based on a set of metrics associated with the set of pods;
calculate a scaling coefficient based on the count of the set of real-time requests, the health ratio value, the available request handling capacity value, and the empirical coefficient value, wherein the scaling coefficient is associated with a scaling of the set of pods;
modify the set of pods based on the scaling coefficient and a count of the set of pods;
control an instantiation of the modified set of pods; and
route the set of real-time requests to the modified set of pods based on the instantiation of the modified set of pods.

12. The computer system of claim 11, wherein the modification of the set of pods corresponds to an increase in the count of the set of pods associated with the application or a decrease in the count of the set of pods associated with the application.

13. The computer system of claim 11, wherein the program instructions further cause the processor set to:
determine that a count of the modified set of pods is greater than a count of a threshold set of pods; and
control the instantiation of the threshold set of pods based on the determination that the count of the modified set of pods is greater than the count of the threshold set of pods.

14. The computer system of claim 11, wherein the program instructions further cause the processor set to:
generate a data structure for each real-time request of the received set of real-time requests; and
determine the count of the set of real-time requests to access the service based on the data structure for each real-time request of the set of real-time requests.

15. The computer system of claim 14, wherein the data structure for each real-time request of the set of real-time requests comprises an identifier associated with the service and an identifier associated with a corresponding real-time request of the set of real-time requests.

16. The computer system of claim 14, wherein the program instructions further cause the processor set to:
associate a priority level with each real-time request of the set of real-time requests based on at least one of priority data or historical data associated with the service; and
modify the data structure for each real-time request of the set of real-time requests based on the association, wherein the modified data structure comprises the priority level associated with the real-time request corresponding to the data structure.

17. The computer system of claim 16, wherein the program instructions further cause the processor set to:
route the set of real-time requests to the modified set of pods based on the priority level associated with each real-time request of the set of real-time requests.

18. The computer system of claim 16, wherein the program instructions further cause the processor set to:
calculate the available request handling capacity value for each pod of the set of pods based on a maximum request handling capacity of a corresponding pod of the set of pods and a first subset of real-time requests of the set of real-time requests associated with the corresponding pod of the set of pods.

19. A computer-program product to scale a set of pods implementing a service provided by an application, the computer-program product comprising:
one or more computer-readable storage media; and
program instructions stored on the one or more computer-readable storage media to perform operations comprising:
detecting a trigger associated with a scaling of the set of pods associated with the application;
determining a count of a set of real-time requests for accessing the service of the application, wherein the count of the set of real-time requests is determined based on the trigger;
obtaining a health ratio value for each pod of the set of pods based on the trigger;
determining an available request handling capacity value for each pod of the set of pods based on the trigger;
determining an empirical coefficient value based on a set of metrics associated with the set of pods;
calculating a scaling coefficient based on the count of the set of real-time requests, the health ratio value, the available request handling capacity value, and the empirical coefficient value, wherein the scaling coefficient is associated with the scaling of the set of pods;
modifying the set of pods based on the scaling coefficient and a count of the set of pods; and
controlling an instantiation of the modified set of pods.

20. The computer-program product of claim 19, wherein the modification of the set of pods corresponds to an increase in the count of the set of pods associated with the application or a decrease in the count of the set of pods associated with the application.
